(19) United States
(12) Patent Application Publication
(10) Pub. No.: US 2022/0072698 A1
(43) Pub. Date: Mar. 10, 2022

(54) MAGNETIC BASE FOR ROBOTIC ARM

(71) Applicant: Magswitch Technology Worldwide Pty Lt., Lafayette, CO (US)

(72) Inventors: David H. Morton, Boulder, CO (US); Paul J. Karp, Arvada, CO (US)

(21) Appl. No.: 17/291,197

(22) PCT Filed: Nov. 5, 2019
(86) PCT No.: PCT/US2019/059918

§ 371 Date: May 4, 2021

Related U.S. Application Data
(60) Provisional application No. 62/755,716, filed on Nov. 5, 2018.

(51) Int. Cl. B25J 9/00; B25J 5/00; B25J 13/08; B25J 9/16; H01F 7/02

(52) U.S. Cl. CPC B25J 9/0009; B25J 5/007; H01F 7/02; B25J 9/1674; B25J 13/087

(57) ABSTRACT

Embodiments of the present disclosure relate to a magnetic base for a programmable machine. In an exemplary embodiment, magnetic system comprises a robotic arm and a magnetic base. The robotic arm comprises a pivot joint allowing the robotic arm to move in at least one direction. The magnetic base is coupled to the robotic arm and supports the robotic arm. The magnetic base comprises a magnetic coupler and a wheel. The magnetic coupler comprises a workpiece contact interface and a magnet assembly configurable between off and on states. The off state produces a first magnetic field at the workpiece contact interface that is less than a second magnetic field produced at the workpiece contact interface when in the on state. The wheel rotates about an axis and supports the magnetic base to permit a movement of the magnetic system.

### TECHNICAL FIELD

Aspects of this disclosure relate to magnetic coupling devices. More specifically, the present disclosure relates to magnetic systems including magnetic coupling devices coupled to programmable machines.

### BACKGROUND

Magnetic coupling devices couple to ferromagnetic workpieces and/or ferromagnetic surfaces. An exemplary magnetic coupling device is a switchable magnetic coupling device including a magnet that is actuatable between an “off” state and an “on” state. When the magnet is in an “on” state, the magnetic coupling device is configured to couple to a ferromagnetic workpiece and/or ferromagnetic surface. When the magnet is in an “off” state, the magnetic coupling device no longer couples to the ferromagnetic workpiece and/or the ferromagnetic surface.

### SUMMARY

Embodiments included herein relate to magnetic systems including magnetic coupling devices coupled to programmable machines. Exemplary embodiments include, but are not limited to, the following examples.

In an example, a magnetic system for coupling to a ferromagnetic workpiece, comprises: a robotic arm comprising at least one pivot joint configured to allow the robotic arm to move in at least one direction; a magnetic base coupled to the robotic arm and configured to support the robotic arm, the magnetic base comprising: a magnetic coupler comprising a workpiece contact interface and a magnet assembly configurable between an off state and an on state, the off state producing a first magnetic field at the workpiece contact interface and the on state producing a second magnetic field at the workpiece contact interface, the second magnetic field being greater than the first magnetic field; and a wheel coupled to the magnetic base and configured to rotate about an axis, the wheel positionable to support the magnetic base to permit a movement of the magnetic system.

In an example according to the previous paragraph, the wheel is further configured to swivel about a vertical axis angled relative to the axis.

In an example according to any one of the previous paragraphs, the wheel is moveable between a first position wherein the magnetic coupler is contacting the ferromagnetic workpiece and a second position wherein the magnetic coupler is spaced apart from the ferromagnetic workpiece, optionally the wheel is further configured to vertically translate along a vertical axis between the first position and the second position.

In an example according to any one of the previous paragraphs, the magnetic base comprises a wheel set including the wheel, wherein the wheel set comprises two or more wheels.

In an example according to the previous paragraph, the wheel set comprises a housing arranged between the two or more wheels, wherein the housing comprises a wheel magnet assembly configurable between an on state and an off state, the on state producing a magnetic field external to the housing that is greater than an external magnetic field produced by the off state.

In an example according to the previous paragraph, the on state and the off state of the wheel magnet assembly is configurable independent of the on state and the off state of the magnet assembly of the magnetic coupler.

In an example according to one of the two previous paragraphs, the wheel magnet assembly is configurable to a partial on state, the partial on state producing a magnetic field external to the housing that is less than the external magnetic field produced when the wheel magnet assembly is in the on state and is greater than the external magnetic field produced when the wheel magnet assembly is in the off state.

In an example according to any one of the previous paragraphs, the magnetic base comprises more than one wheel set, wherein each wheel set comprises two or more wheels.

In an example according to any one of the previous paragraphs, the magnetic base comprises a manual actuator, an electrical actuator, a pneumatic actuator, or a hydraulic actuator configured to actuate the magnet assembly between the off state and the on state.

In an example according to any one of the previous paragraphs, the magnetic base comprises a ratchet configured to retain the magnet assembly in either the off state or the on state.

In an example according to any one of the previous paragraphs, the at least one magnet is configured to be actuated to a partial on state, the partial on state producing a third magnetic field at the workpiece contact interface, the third magnetic field being greater than the first magnetic field and less than the second magnetic field.

In an example according to the previous paragraph, the magnetic base comprises a manual actuator, an electrical actuator, a pneumatic actuator, or a hydraulic actuator configured to actuate the magnet assembly to the partial on state.

In an example according to any one of the previous paragraphs, further comprises a sensing system configured to sense when the magnetic coupler has insufficient contact with the ferromagnetic workpiece.

In an example according to any one of the previous paragraphs, further comprising a sensing system configured to sense a breakaway force of the magnetic base.

In an example according to the previous paragraph, further comprising a controller configured to lookup a breakaway force required to perform a programmable function of the robotic arm and prevent the programmable function from being performed when the breakaway force sensed by the sensing system is less than the breakaway force for the programmable function.

In an example according to any one of the previous paragraphs, further comprising a sensing system configured to sense a location of the magnetic system on a ferromagnetic workpiece.

In an example according to any one of the previous paragraphs, further comprising a programmable machine module configured to control movement of the magnetic system via rotation of the wheel.

In an example according to any one of the previous paragraphs, wherein the magnetic assembly comprises a first permanent magnet and a second permanent magnet in a stacked relationship with the first permanent magnet, wherein the magnet assembly produces the first magnetic field at the workpiece contact interface when the second permanent magnet is in a first state relative to the first permanent magnet and the magnet assembly produces the second magnetic field at the workpiece contact interface when the second permanent magnet is in a second state relative to the first permanent magnet.

In another exemplary embodiment, a non-transitory computer-readable medium comprising instructions that when executed by a processor cause the processor to: relocate a magnetic system from a first location on a ferromagnetic workpiece to a second location on the ferromagnetic workpiece using a wheel incorporated into the magnetic system, the magnetic system comprises: a robotic arm comprising at least one pivot joint configured to allow the robotic arm to move in at least one direction; a magnetic base coupled to the robotic arm and configured to support the robotic arm, the magnetic base comprising: a magnetic coupler comprising a workpiece contact interface and a magnet assembly configurable between an off state and an on state, the off state producing a first magnetic field at the workpiece contact interface and the on state producing a second magnetic field at the workpiece contact interface, the second magnetic field being greater than the first magnetic field; and the wheel configured to rotate about an axis; and transition the at least one magnet from the off state to the on state.

In an example according to the previous paragraph, further comprising instructions that when executed by the processor cause the processor to: transition the at least one magnet from the on state to the off state; relocate the magnetic system from the second location to a third location on the ferromagnetic workpiece; and transition the at least one magnet from the off state to the on state.

In even another exemplary embodiment, a magnetic base configured to be coupled to a tool and support the tool, comprises: a magnetic coupler comprising a workpiece contact interface and a magnet assembly configured to be actuated between an off state and an on state, the off state producing a first magnetic field at the workpiece contact interface and the on state producing a second magnetic field at the workpiece contact interface, the second magnetic field being greater than the first magnetic field; and a wheel configured to rotate about an axis to permit movement of the the magnetic base.

In yet another exemplary embodiment, a magnetic system for coupling to a ferromagnetic workpiece, comprises: an articulating programmable machine; a controller operatively coupled to the articulating robotic arm to control a position of an end of the articulating robotic arm relative to the ferromagnetic workpiece; a magnetic base supporting the articulating robotic arm, the magnetic base including magnetic coupling means for selectively coupling the magnetic base to the ferromagnetic workpiece to stabilize the articulating robotic arm relative to the ferromagnetic workpiece and transport means for moving the magnetic system from a first location relative to the ferromagnetic workpiece to a second location relative to the ferromagnetic workpiece while the magnetic coupling means are decoupled from the ferromagnetic workpiece.

In even another exemplary embodiment, a magnetic system for coupling to a ferromagnetic workpiece, comprises: a robotic arm comprising at least one pivot joint configured to allow the robotic arm to move in at least one direction; a magnetic base coupled to the robotic arm and configured to support the robotic arm, the magnetic base comprising: a magnetic coupler comprising a workpiece contact interface and a magnet assembly configurable between an off state and an on state, the off state producing a first magnetic field at the workpiece contact interface and the on state producing a second magnetic field at the workpiece contact interface, the second magnetic field being greater than the first magnetic field; and a transport system coupled to the magnetic base and positioned to support the magnetic base to permit a movement of the magnetic system.

In an example according to the previous paragraph, the transport system comprises a housing, wherein the housing comprises a transport magnet assembly configurable between an on state and an off state.

In an example according to the previous paragraph, wherein the on state and the off state of the transport magnet assembly is configurable independent of the on state and the off state of the magnet assembly of the magnetic coupler.

In yet another exemplary embodiment, a magnetic system for coupling to a ferromagnetic workpiece, comprises: a robotic arm comprising at least one pivot joint configured to allow the robotic arm to move in at least one direction; a magnetic base coupled to the robotic arm and configured to support the robotic arm, the magnetic base comprising: a magnetic coupler comprising a workpiece contact interface and a magnet assembly configurable between an off state and an on state, the off state producing a first magnetic field at the workpiece contact interface and the on state producing a second magnetic field at the workpiece contact interface, the second magnetic field being greater than the first magnetic field; and a transport system coupled to the magnetic base and positioned to support the magnetic base to permit a movement of the magnetic system; a sensing system configured to sense a breakaway force of the magnetic base; and a controller configured to lookup a breakaway force required to perform a programmable function of the robotic arm and prevent the programmable function from being performed when the breakaway force sensed by the sensing system is less than the breakaway force for the programmable function.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 is a perspective view of an exemplary magnetic system including a magnetic coupling device coupled to a programmable machine.

FIG. 2 is a perspective view of the magnetic coupling device depicted in FIG. 1.

FIG. 3 is a side view of the magnetic coupling device depicted in FIG. 2.

FIG. 4 is an exploded view of the magnetic coupling device depicted in FIG. 2.

FIG. 5 is a perspective view of the wheel sets included in the magnetic coupling device depicted in FIG. 1.

FIGS. 6A-6B are cross sections of a magnetic coupler included in the magnetic coupling device depicted in FIG. 4.

FIG. 7 is an exploded view of the magnetic coupler depicted in FIGS. 6A-6B.

FIG. 8 is a cross section of a wheel set included in the magnetic coupling device depicted in FIG. 5.

FIG. 9 is an exploded view of a wheel set depicted in FIG. 8.

FIG. 10 is a perspective view of another exemplary magnetic system including an exemplary magnetic coupling device coupled to a programmable machine.

FIG. 11 is a perspective view of the magnetic coupling device depicted in FIG. 10.

FIG. 12 is a side view of the magnetic coupling device depicted in FIG. 11.

FIG. 13 is a perspective view of another exemplary magnetic system including an exemplary magnetic coupling device coupled to a programmable machine.

FIG. 14 is a perspective view of the magnetic coupling device depicted in FIG. 13.

FIG. 15 is a side view of the magnetic coupling device depicted in FIG. 14.

FIG. 16 is an exploded view of the magnetic coupling device depicted in FIG. 14.

FIGS. 17A-17B are cross sections of a magnetic coupler included in the magnetic coupling device depicted in FIG. 15.

FIG. 18 is an exploded view of the magnetic coupler depicted in FIGS. 17A-17B.

FIG. 19 is a block diagram of another exemplary magnetic system.

While the invention is amenable to various modifications and alternative forms, specific embodiments have been shown by way of example in the drawings and are described in detail below. The intention, however, is not to limit the invention to the embodiments described. On the contrary, the invention is intended to cover all modifications, equivalents, and alternatives falling within the scope of the invention as defined by the appended claims.

### DETAILED DESCRIPTION

In the figures as well as in the preceding section of this specification, terms such as ‘upper’, ‘axial’ and other terms of reference are used to facilitate an understanding of the technology here described and are not to be taken as absolute and limiting reference indicators, unless the context indicates otherwise. The terms “couples”, “coupled”, “coupler” and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

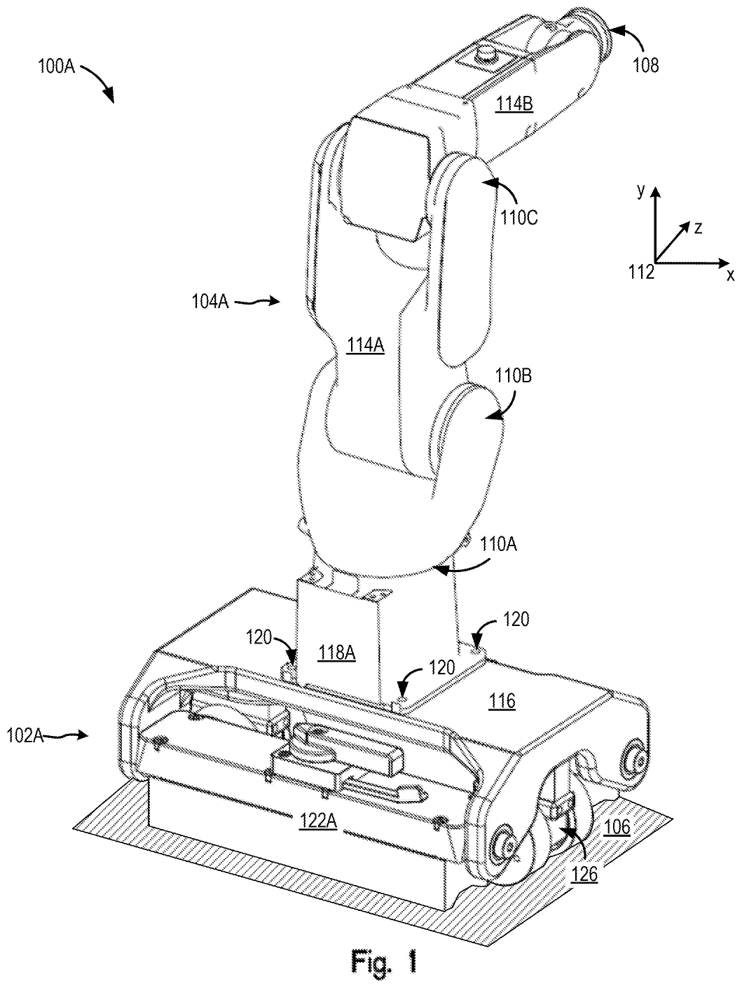

FIG. 1 illustrates a perspective view of an exemplary magnetic system 100A. The magnetic system 100A includes a magnetic coupling device 102A coupled to a programmable machine 104A. Generally, the magnetic coupling device 102A can be used to releasably secure the programmable machine 104A to a ferromagnetic surface 106. For example, once the magnetic system 100A is in a desired location, the magnetic coupling device 102A can be actuated to form a magnetic circuit through the ferromagnetic surface 106 and thereby secure the magnetic system 100A to the ferromagnetic surface 106. The programmable machine 104A can then perform one or more programmed functions. When the programmable machine 104A is finished performing one or more programmed functions at the desired location, the magnetic coupling device 102A may be de-actuated and the magnetic system 100A may be moved to another desired location and the process repeated. These features of the magnetic system 100A is described in detail below.

In at least one example, the programmable machine 104A is a robotic arm and a plurality of different tools (not shown) can be attached to the end 108 of the robotic arm 104A. In at least some embodiments, manufacturing tools can be secured to the end 108 of the robotic arm 104A to facilitate autonomous or semi-autonomous manufacturing. For example, a gripper (e.g., magnetic, vacuum, tactile, etc.) can be coupled to the end 108 to move pieces and/or to facilitate the assembly of a device. Other examples of manufacturing tools that can be secured to the end 108 of the robotic arm 104A include, but are not limited to, welders, sensors, injectors, sprayers, etc.

In some embodiments, other types of transporting systems, such as mechanical gantries, crane hoists and additional systems which lift and/or transport ferromagnetic workpieces, may be used as the programmable machine 104A or in place of the programmable machine 104A. In some embodiments, the programmable machine 104A is replaced by a manufacturing tool, such as a drill.

In the illustrated embodiment, the programmable machine 104A includes a plurality of pivot points 110 (e.g., joints). Due to the pivot points 110, the programmable machine 104A has a plurality of degrees of freedom, allowing the programmable machine 104A to move along or about an x-axis, a y-axis, and a z-axis of the coordinate system 112. For example, the first pivot point 110A allows the programmable machine 104A to rotate about the y-axis of the coordinate system 112. The second pivot point 1106 allows the portion 114A of the programmable machine 104A to translate along the x-z plane of the coordinate system 112. And, the third pivot point 110C allows the portion 114B to translate along the y-axis of the coordinate system 112. As such, the end 108 can move to various locations within the coordinate system 112.

A top portion 116 of the magnetic coupling device 102A is mechanically coupled to a base 118A of the programmable machine 104A. In at least one example, the base 118A is mechanically coupled to the top portion 116 via one or fasteners (e.g., bolts). The fasteners extend through apertures 120 in the base 118A and secure to threaded bores (not shown) into the top portion 116. However, threaded bores (not shown) into the top portion 116 are only one example and not meant to be limiting. For example, the top portion 116 may include different arrangements and numbers of threaded bores that correspond to different types of programmable machine bases. As such, the programmable machine 104A may be replaced by various other types of programmable machines (not illustrated) and coupled to the top portion 116.

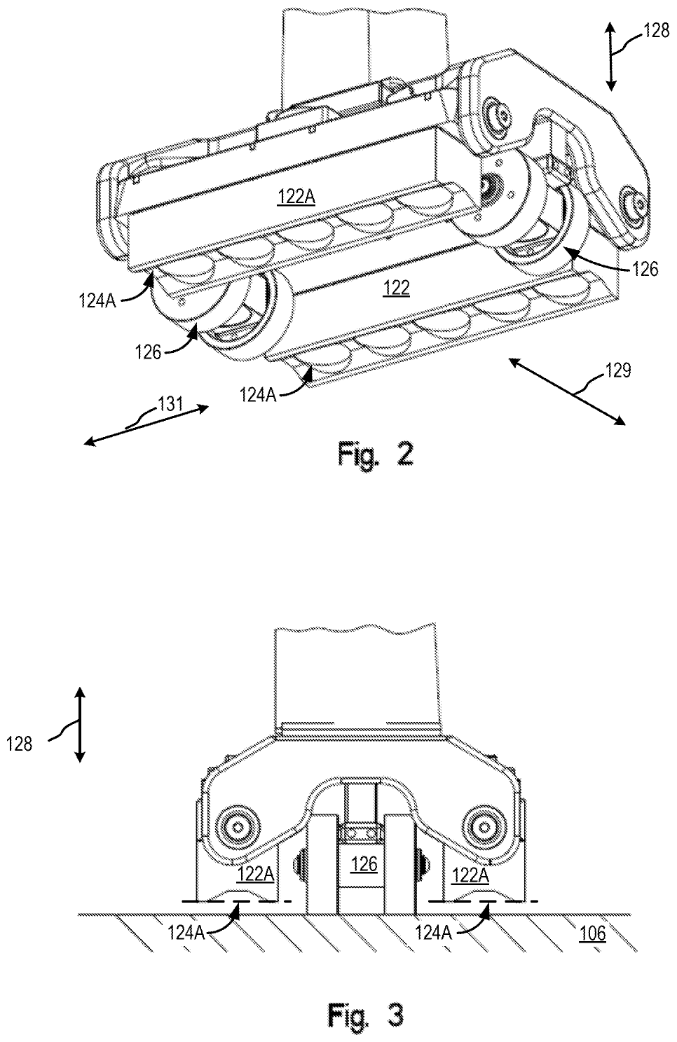

Referring to FIGS. 2 and 3, a perspective view of the magnetic coupling device 102A and a side view of the magnetic coupling device 102A are illustrated, respectively. In the illustrated embodiment, the magnetic coupling device 102A includes two magnetic couplers 122A. Each of the magnetic couplers 122A is configured to switch between an “on state” and an “off state”. When a magnetic coupler 122A is in an on state, a first magnetic circuit is created through a ferromagnetic workpiece and/or ferromagnetic surface 106 at a workpiece contact interface 124A. Alternatively, when a magnetic coupler 122A is in an off state, a second magnetic circuit is not created (or substantially not created) through a ferromagnetic workpiece 106 at the workpiece contact interface 124A and instead is substantially contained within the housing of the magnetic coupler 122A. The internal components that enable the switching of the magnetic coupler 122A between an on state and an off state are described in more detail below.

In some embodiments, the magnetic coupling device 102A includes wheel sets 126 coupled to the top portion 116 and configured to facilitate movement of the magnetic coupling device 102A about a ferromagnetic surface 106. While wheels sets 126 are depicted in the illustrated embodiment, other suitable transport systems may be used instead of the wheel sets 126, such as tracks, skis, walking machine, hover mechanism, etc.

As stated, the wheel sets 126 facilitate the movement of the magnetic system 100A to various locations. To facilitate movement of the magnetic system 100A to various locations, the wheel set 126 may be configured to rotate about the central axis 129 (of FIG. 2). Additionally, or alternatively, the wheels may also swivel about the axis 128 (of FIGS. 2 and 3), which is angled relative to the central axis 129. While the illustrated embodiment depicts two wheel sets 126, in other embodiments, the magnetic coupling device 102A may include more than two wheel sets 126. Additionally, or alternatively, while the illustrated embodiment depicts each wheel set 126 as including two wheels, each wheel set 126 may only include one wheel or more than two wheels. Additionally, or alternatively, while the illustrated embodiment depicts two wheel sets 126 arranged along a horizontal axis 131, the wheel sets 126 may be arranged in various other positions. For example, the wheel sets 126 may be arranged side by side or may include four wheel sets 126 arranged proximal the corners of the magnetic coupling device 102A

In some embodiments, the wheel sets 126 are configured to translate along the y axis 128 depicted in FIG. 3. For example, when the magnetic couplers 122A are in an off state, the wheel sets 126 are at a first position shown in FIG. 3, so the workpiece contact interface 124A is spaced apart from the ferromagnetic surface 106. This allows the wheel sets 126 and the magnetic system 100A to roll to various locations. Then, when the magnetic couplers 122A are in an on state, the wheel sets 126 retract into the magnetic coupling device 102A so the workpiece contact interface 124A contacts the ferromagnetic surface 106.

In at least some embodiments, the wheel sets 126 are actuatable along the y axis 128 by a linear actuator. Exemplary linear actuators include but are not limited to electrical, pneumatic, and hydraulic actuators. In at least some other embodiments, the wheel sets 126 may be spring-loaded to bias the wheel sets 126 in a downward direction so there is separation between the workpiece contact interface 124A and the ferromagnetic surface 106. Then, when the magnetic couplers 122A are actuated and the magnetic couplers 122A are in an on state, the magnetic attraction between the magnetic couplers 122A and the ferromagnetic surface 106 overcomes the force provided by the springs and the wheel sets 126 translate upwards along the y axis 128 until the workpiece contact interface 124A contacts the ferromagnetic surface 106.

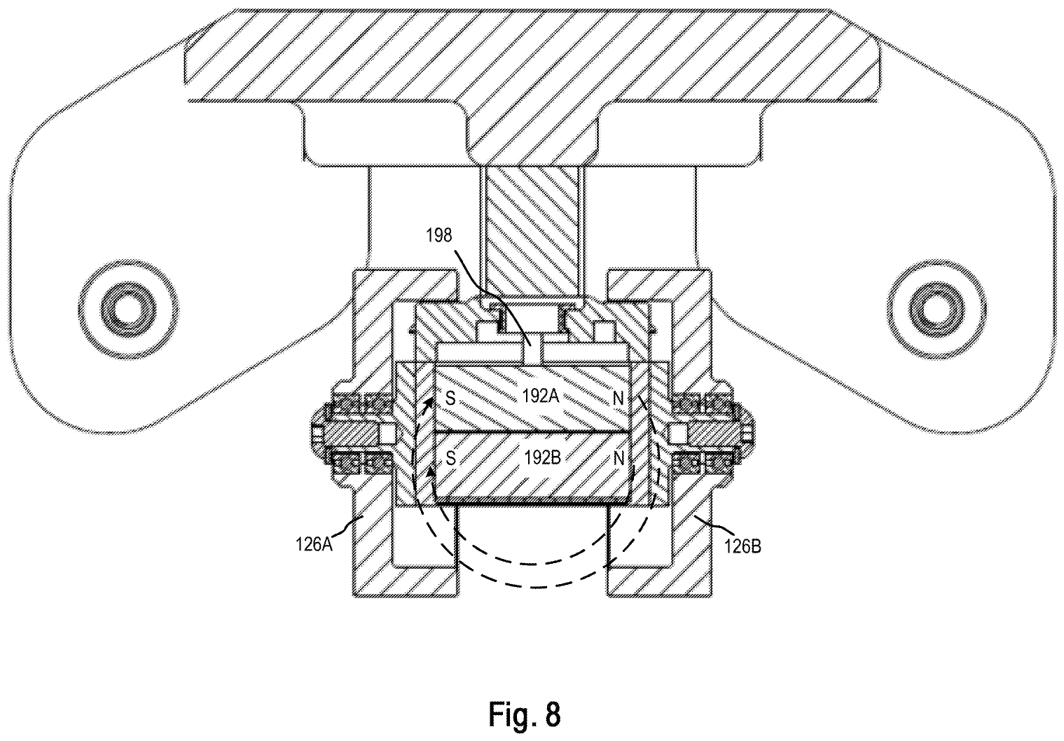

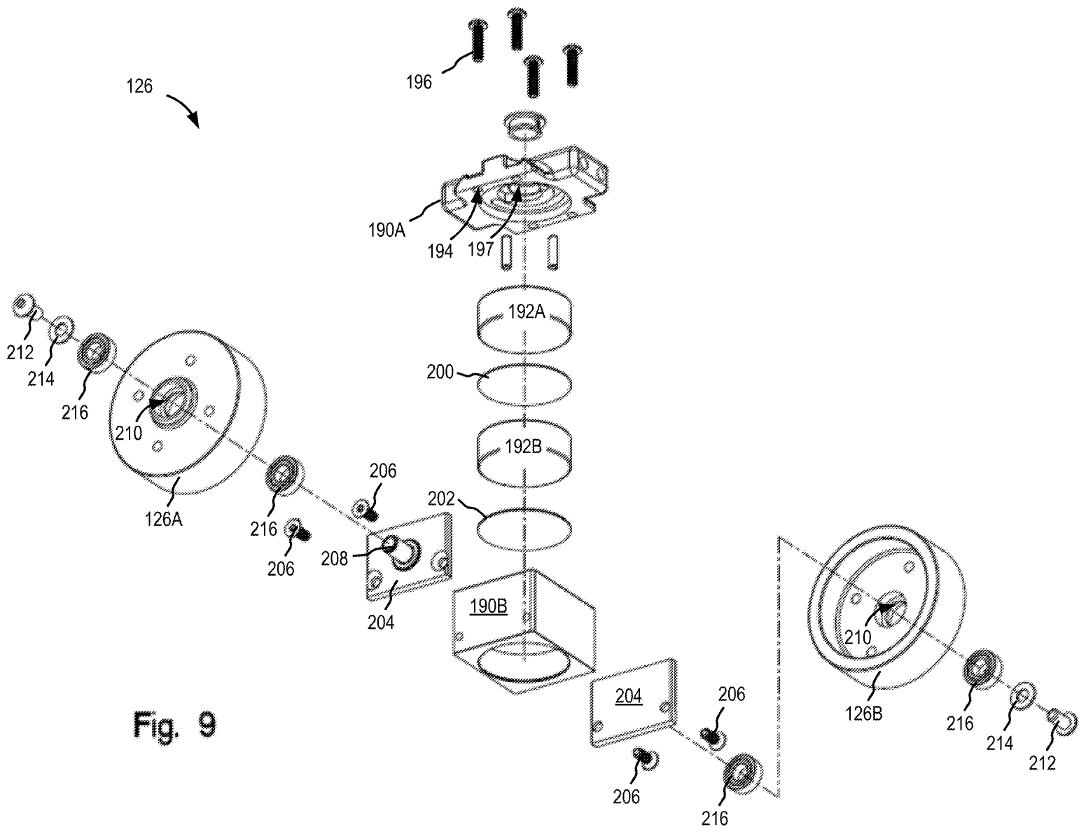

The wheel sets 126 may also include internal magnets, as illustrated in FIGS. 8 and 9. The magnets create a magnetic circuit with the ferromagnetic surface 106 so the magnetic system 100A maintains contact with the ferromagnetic surface 106 while the magnetic system 100A is moving from one location to another.

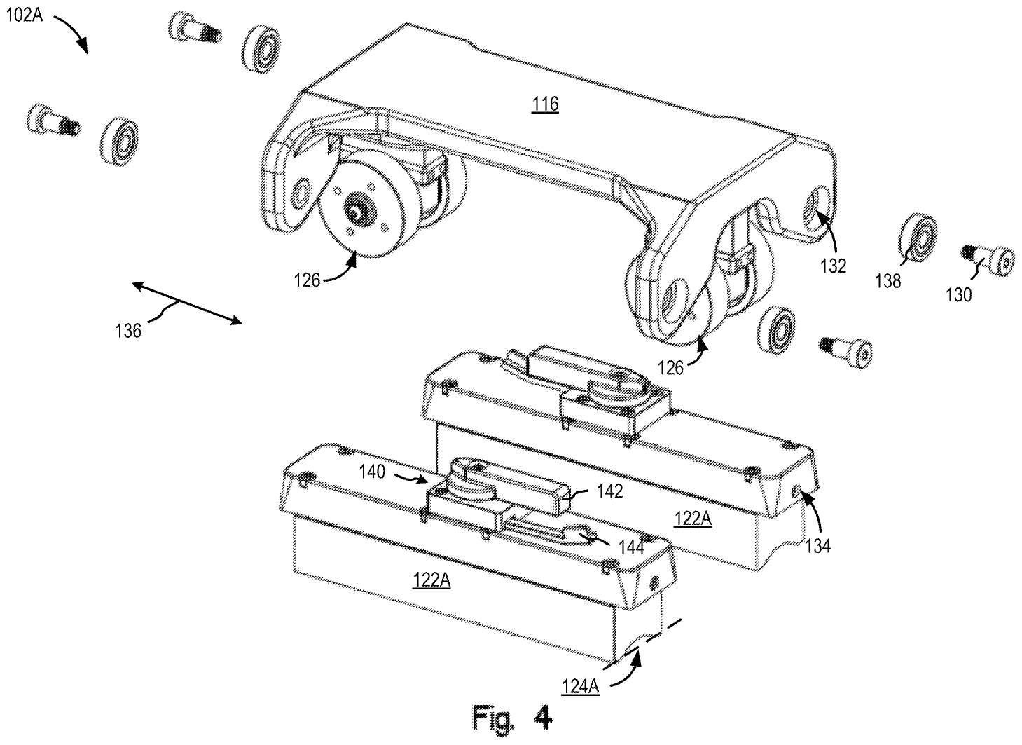

FIG. 4 depicts an exploded perspective view of the magnetic coupling device 102A. As illustrated, the top portion 116 is secured to the magnetic couplers 122A by a plurality of fasteners 130 (e.g., bolts). The fasteners 130 extend through apertures 132 in the top portion 116 and secure to threaded apertures 134 in each of the magnetic couplers 122A. The fasteners 130 allow the magnetic couplers 122A to rotate about an axis 136 with respect to the top portion 116. By being able to rotate about the axis 136, the workpiece contact interface 124A of the magnetic couplers 122A can lay flush against the ferromagnetic surface 106. In at least some embodiments, the magnetic coupling device 102A includes bearings 138 to facilitate rotation of the magnetic couplers 122A with respect to the top portion 116.

In some embodiments, the bearings 138 and the fasteners 130 may be nonconductive. In these embodiments, the bearings 138 and the fasteners 130 being nonconductive can isolate the magnetic couplers 122A from the top portion 116 and the base 118A of the programmable machine 104A. In some examples, the bearings 138 may be greater than 1 mm thick. In some other examples, the bearings 138 may be greater than 2 mm thick. In even some other examples, the bearings 138 may be more than 3 mm thick. In some embodiments, the thickness of the bearings 138 may be correlated to the voltages at which the magnetic system 100A is operating. For example, the thickness of the bearings 138 may increase as the voltage at which the magnetic system 100A is operating increases.

While bearings 138 are illustrated, in other embodiments, the bearings 138 may be bushings, spacers, specific types of bearings, etc., which may be nonconductive in some embodiments.

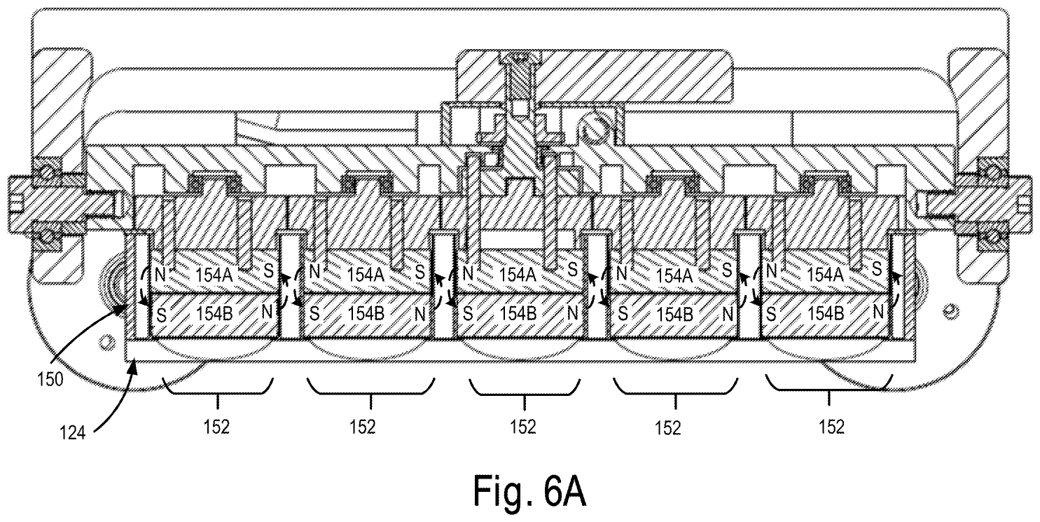

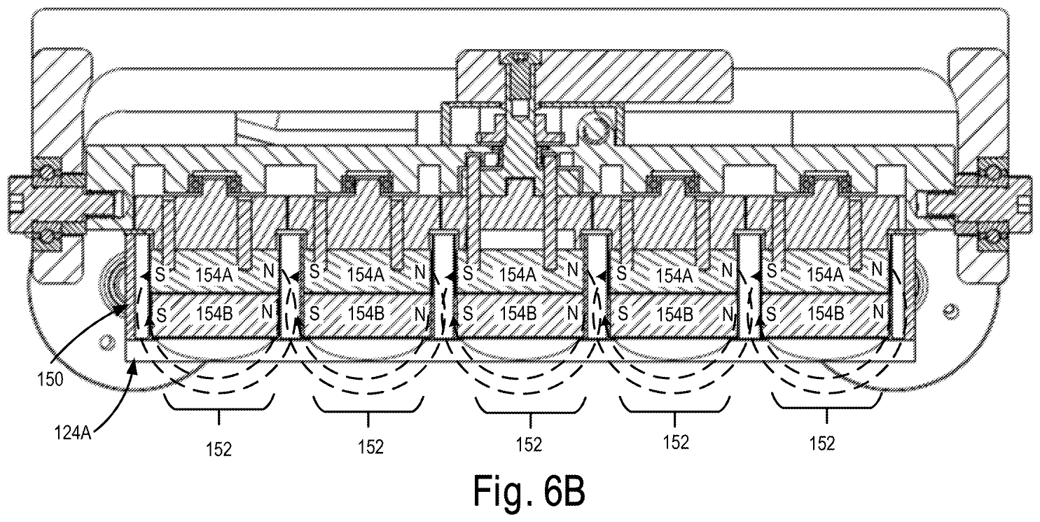

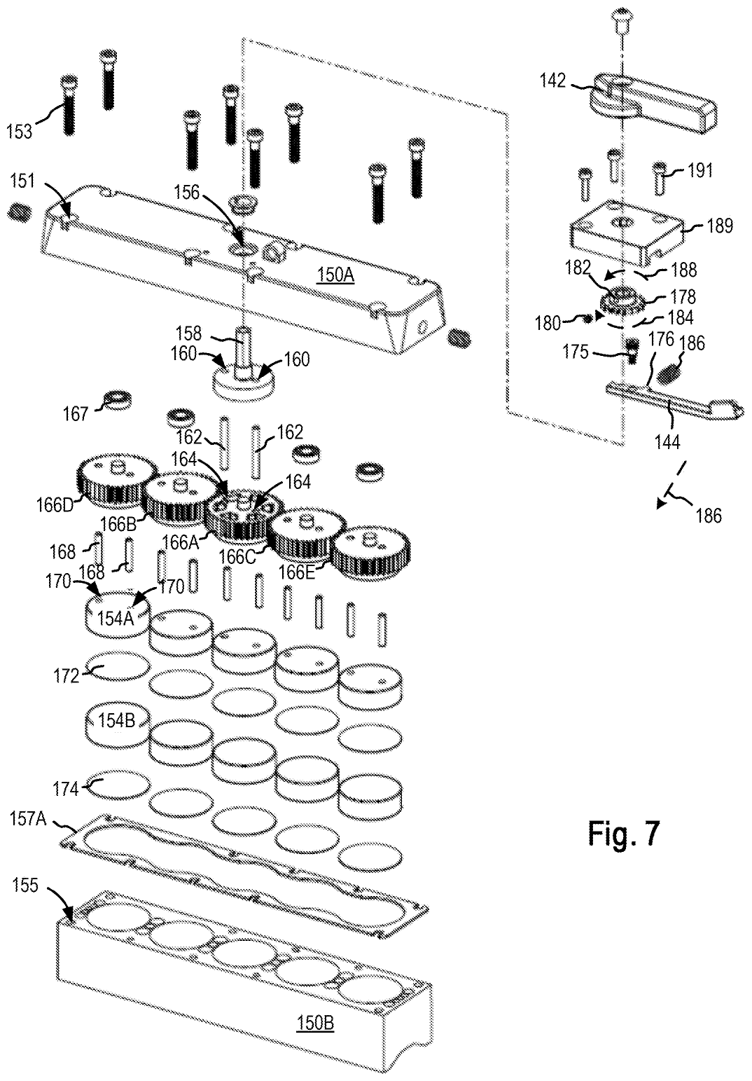

Each of the magnetic couplers 122A may also include an actuating mechanism 140. The actuating mechanism 140 includes an actuator 142 that turns the magnetic couplers 122A from an off state to an on state when the actuator 142 is rotated. The actuator 142 rotates an internal gear mechanism that rotates internal magnets relative to one another, as illustrated in FIGS. 6 and 7. To turn the magnetic coupler 122A from an on state to an off state, the actuating mechanism 140 may include a ratchet 144 that locks the magnetic coupler 122A in an on state and releases the magnetic coupler 122A from a locked on state when actuated, as discussed in more detail below in relation to FIG. 7.

In at least some embodiments, the actuator 142 is rotated 180 degrees to turn the magnetic coupler 122A from an off state to a fully on state. In at least some embodiments, the actuator 142 may be rotated more than 0 degrees but less than 180 degrees to partially active the magnetic coupler 122A, thereby providing a third, non-zero magnetic circuit with the ferromagnetic surface 106 that is less than when the magnetic coupler 122A is in a fully-on state. This partially on state may be useful to partially couple the magnetic coupling device 102A to a ferromagnetic surface 106, but still allow some movement of the magnetic system 100A relative to the ferromagnetic surface 106 in order to fine tune the position of the magnetic system 100A on the ferromagnetic surface 106.

While a manual actuator 142 is depicted, other types of actuators may be used to actuate the magnetic coupler 122A. Exemplary engagement portions and actuators are disclosed in U.S. Pat. No. 7,012,495, titled SWITCHABLE PERMANENT MAGNETIC DEVICE; U.S. Pat. No. 7,161,451, titled MODULAR PERMANENT MAGNET CHUCK; U.S. Pat. No. 8,878,639, titled MAGNET ARRAYS, U.S. Provisional Patent Application No. 62/248,804, filed Oct. 30, 2015, titled MAGNETIC COUPLING DEVICE WITH A ROTARY ACTUATION SYSTEM, docket MTI-0007-01-US-E; and U.S. Provisional Patent Application No. 62/252,435, filed Nov. 7, 2015, titled MAGNETIC COUPLING DEVICE WITH A LINEAR ACTUATION SYSTEM, docket MTI-0006-01-US-E, the entire disclosures of which are herein expressly incorporated by reference.

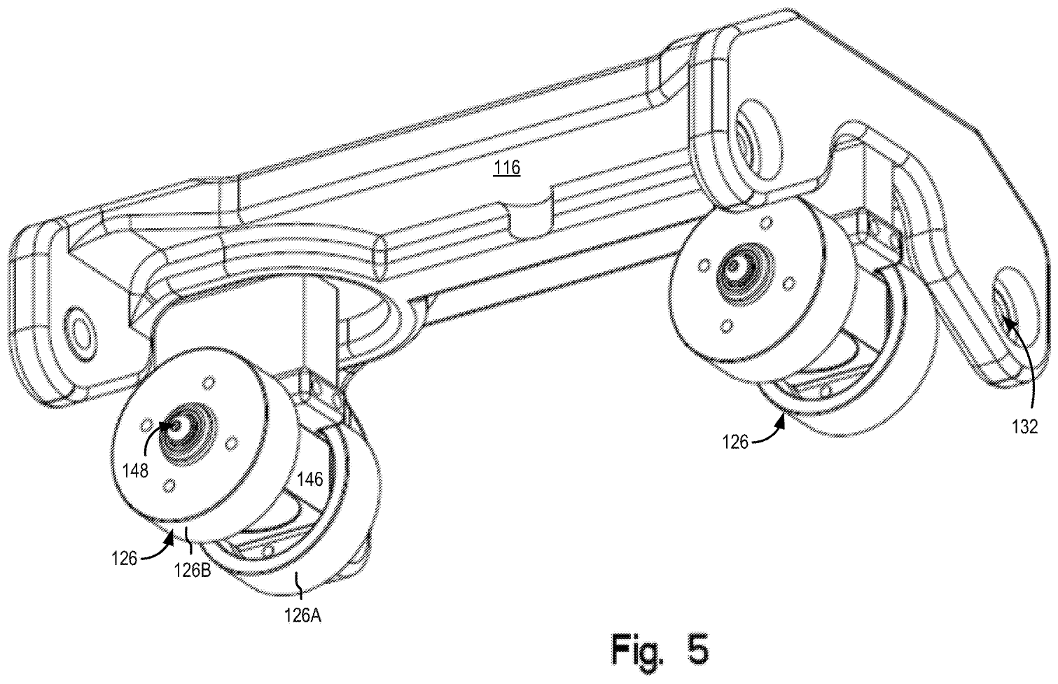

FIG. 5 depicts a bottom perspective view of the top portion 116. As shown, the wheel sets 126 include a housing 146 arranged between two wheels 126A, 126B. The housing 146 includes a set of magnets (illustrated in FIGS. 8 and 9) that are configured to turn on and off. When the magnets are turned off, a magnetic circuit is substantially confined with the housing 146. When the magnets are turned on, a magnetic circuit is formed through the ferromagnetic surface 106. As stated above, the magnetic circuit formed through the ferromagnetic surface 106 facilitates the magnetic system 100A maintaining contact with the ferromagnetic surface 106. As illustrated, the wheel sets 126 include axles 148 that extend through the wheels 126A, 126B and allow the wheels 126A, 126B to rotate about an axis extending along the axles 148 (e.g., the axis 129 of FIG. 2).

FIGS. 6A-6B illustrate the cross section of the magnetic coupler 122A in an off state and an on state, respectively. As illustrated, the magnetic coupler 122A includes a housing 150 that houses a magnetic assembly 152. In some embodiments, the magnetic assembly 152 includes magnet groups 152. Each magnet group 152 includes an upper magnet 154A and a lower magnet 154B positioned in a stacked relationship. While the illustrated embodiment includes five magnet groups 152, in other embodiments, the magnetic coupler 122A includes greater than five magnetic groups 152 or less than five magnetic groups 152 (e.g., one magnetic group 152).

In some embodiments, the upper magnets 154A are permanent magnets and the lower magnets 154B are permanent magnets. In some embodiments, the upper permanent magnets 154A and the lower permanent magnets 154B are diametrically polarized and include north-pole portions and south-pole portions. The lower permanent magnets 154B are fixed within a housing of the magnetic coupler 122A and the upper permanent magnets 154A are actuatable relative to the lower permanent magnets 154B within the housing 150. When the magnetic coupler 122A is in an off state, as illustrated in FIG. 6A, the N-pole portions of the upper permanent magnets 154A are arranged adjacent the S-pole portions of the lower permanent magnets 154B and the S-pole portions of the upper permanent magnets 154A are arranged adjacent the N-pole portions of the lower permanent magnets 154B. When the magnetic coupler 122A is in this configuration, the magnetic circuit is shunted and substantially confined with the housing 150. As such, the magnetic field produced by the magnetic coupler 122A at the workpiece contact interface 124A is substantially zero, as shown by the magnetic field lines in FIG. 6A. Conversely, when the magnetic coupler 122A is in an on state, as illustrated in FIG. 6B, the N-pole portions of the upper permanent magnets 154A are arranged adjacent the N-pole portions of the lower permanent magnets 154B and the S-pole portions of the upper permanent magnets 154A are arranged adjacent the S-pole portions of the lower permanent magnets 154B. When the magnetic coupler 122A is in this configuration, the magnetic field produced by the magnetic groups 152 is non-zero at the workpiece contact interface 124A and a magnetic circuit is created through the ferromagnetic surface 106.

In at least some embodiments, the upper permanent magnets 154A can be actuatable to a position between the off state depicted in FIG. 6A and the on state depicted in FIG. 6B, referred to herein as a partial on state. When the magnetic coupler 122A is in a partial on state, the magnetic field at the workpiece contact interface 124A is non-zero but is less than the magnetic field produced by the magnetic coupler 122A when the magnetic coupler 122A is in a fully on state. As such, the magnetic coupler 122A produces a magnetic circuit with the ferromagnetic surface 106 that is weaker than the magnetic circuit produced when the magnetic couple 122A is in a fully on state. By being able to partially activate the magnetic couplers 122A, different strength magnetic circuits can be created with a ferromagnetic surface 106.

FIG. 7 illustrates an exploded view of the magnetic coupler 122A. As illustrated, the housing 150 of the magnetic coupler 122A includes an upper housing portion 150A and a lower housing portion 150B. To couple the upper housing portion 150A to the lower housing portion 150B, the upper housing portion 150A includes apertures 151 through which fasteners 153 extend and are received by threaded apertures 155 in the lower housing portion 150B. In the illustrated embodiment, a gasket 157A may be arranged between the upper housing portion 150A and the lower housing portion 150B.

The upper housing portion 150A also includes another aperture 156 through which a shaft 158 extends. The shaft 158 couples to the actuator 142. As such, rotation of the actuator 142 translates into rotation of the shaft 158. The shaft 158 also includes apertures 160 through which rods 162 extend. And, the rods 162 extend through apertures 164 in a gear 166A. Therefore, rotation of the shaft 158 translates into rotation of the gear 166A.

The gear 166A includes teeth that mesh with teeth included in the gears 166B, 166C. Additionally, the teeth of the gears 166B, 166C mesh with teeth included in the gears 166D, 166E. As such, rotation of the gear 166A translates into rotation of the gears 166B-166E. Furthermore, each gear 166 includes apertures (not shown) through which rods 168 extend. Each upper permanent magnet 154A also includes apertures 170 and the rods 168 protrude into the apertures 170. Therefore, rotation of the gears 166 translates into rotation of the upper permanent magnets 154. In sum, rotation of the actuator 142 translates into rotation of the upper permanent magnets 154A. In at least some embodiments, the magnetic coupling device includes bearings 167 arranged between the gears 166 and the upper housing portion 150A to facilitate rotation of the gears 166.

In the illustrated embodiment, a spacer 172 separates the upper permanent magnets 154A from the lower permanent magnets 154B and facilitates rotation therebetween. The magnetic coupler 122A also includes disks 174 arranged at the bottom of the lower housing portion 150B to support the lower permanent magnets 154B. The disks 174 may be press fitted or otherwise secured such as to seal the lower housing portion 150B.

As stated above, the magnetic coupler 122A includes a ratchet 144 that locks the magnetic coupler 122A in an on state (or a partial on state) and releases the magnetic coupler 122A from the on state when the actuated ratchet 144 is actuated. To lock the magnetic coupler 122A in an on state (or a partial on state), the ratchet 144 includes a protrusion 176 that is received into recesses formed between teeth of a cog 178. The cog 178 is coupled to the shaft 158 via a pin 180 that protrudes into a recess 182 of the cog 178 and protrudes into a recess (not shown) of the shaft 158. As such, when the actuator 142 rotates the shaft 158, the cog 178 is rotated as well. As the cog 178 rotates, the ratchet 144 pivots about a pin 175. As the ratchet 144 pivots about the pin 175, the protrusion 176 slips over the teeth into successive recesses of the cog 178. The teeth and the protrusion 176 are shaped so the cog 178 is only able to rotate in one direction 184 (i.e., from an off-state to an on-state or a partial on-state) when the ratchet 144 is biased towards the cog 178. In at least some embodiments, a spring 186 is configured to bias the ratchet 144 towards the cog 178. To release/actuate the ratchet 144, a force along the direction 188 can be provided which removes the protrusion 176 from the recesses of the cog 178 and allows the cog 178 to rotate in the direction 188 (i.e., from an on-state to a partial on-state or an off-state), opposite the direction 184. The cog 178 may be housed in a housing 189 that is secured to the upper housing portion 150A by fasteners 191.

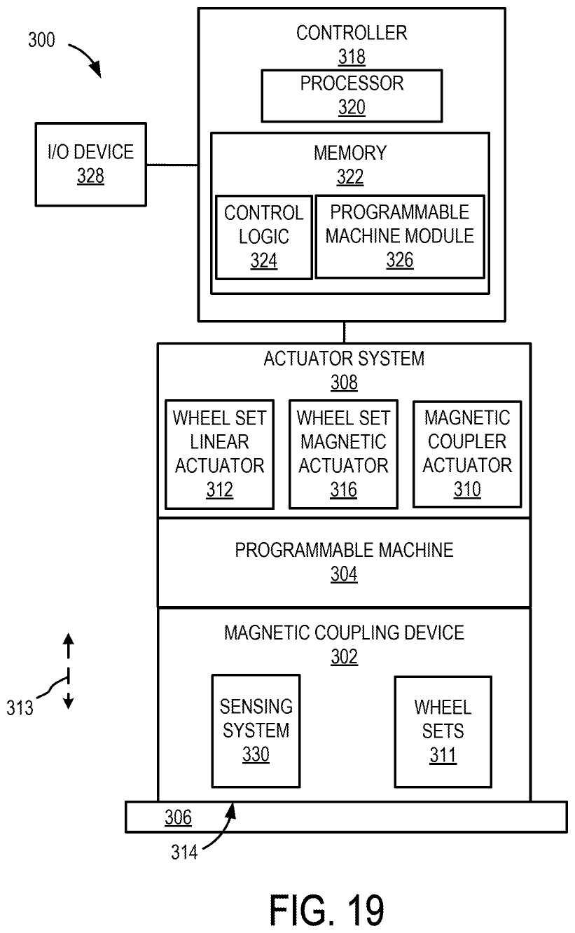

FIG. 8 depicts a cross section of a wheel set 126 and FIG. 9 depicts an exploded view of a wheel set 126. As illustrated, the wheel set 126 includes a housing 192 that houses an upper permanent magnet 192A and a lower permanent magnet 1926. The upper permanent magnet 192A and the lower permanent magnet 192B are positioned in a stacked relationship. The upper permanent magnet 192A and the lower permanent magnet 192B are diametrically polarized and include north-pole portions and south-pole portions. In at least some embodiments, the lower permanent magnet 1926 is fixed within a housing 190 and the upper permanent magnet 192A is rotatable relative to the lower permanent magnets 192B within the housing 190. As such, the magnets 192A, 1926 may function like the magnets 154A, 1546 included in the magnetic coupler 122A. For example, the wheel set 126 may transition from an off-state to an on-state and vice versa. When a wheel set 126 is in an off-state, the N-pole portion of the upper permanent magnets 192A is arranged adjacent to the S-pole portion of the lower permanent magnet 1926 and the S-pole portion of the upper permanent magnet 192A is arranged adjacent the N-pole portion of the lower permanent magnet 192B. When the wheel set 126 is in this configuration, the magnetic circuit is shunted and substantially confined with the housing 190. Conversely, when the wheel set 126 is in an on state, as illustrated in FIG. 8, the N-pole portion of the upper permanent magnet 192A is arranged adjacent the N-pole portion of the lower permanent magnet 192B and the S-pole portion of the upper permanent magnet 192A is arranged adjacent the S-pole portion of the lower permanent magnet 192B. When the wheel set 126 is in this configuration, a magnetic circuit is created through the ferromagnetic surface 106, which facilitates the magnetic system 100A maintaining contact with the ferromagnetic surface 106. To transition the wheel set 126 from an on-state to an off-state, the wheel set may be coupled to an actuator, as depicted in FIG. 19.

As illustrated in FIG. 9, the housing 190 of the wheel set 126 includes an upper housing portion 190A and a lower housing portion 190B. To couple the upper housing portion 190A to the lower housing portion 1906, the upper housing portion 190A includes apertures 194 through which fasteners 196 extend and are received by threaded apertures (not shown) in the lower housing portion 1906. The upper housing portion 190A also includes aperture 197 through which a shaft 198 extends. The shaft 198 may couple to an actuator (not shown) that rotates the upper permanent magnet 192A relative to the lower permanent magnet 192B.

In at least some embodiments, a spacer 200 separates the upper permanent magnet 192A from the lower permanent magnet 1926 and facilitates rotation therebetween. The wheel set 126 also includes a disk 202 arranged at the bottom of the lower housing portion 1906 to support the lower permanent magnet 1926. The disk 202 may be press fitted or otherwise secured such as to seal the lower housing portion 1906.

The wheel set 126 includes two axle bases 204 configured to be secured to the lower housing portion 190B by fasteners 206. Axles 208 project from the axle bases 204. The axles 208 are sized to be received in apertures 210 included in each of the wheels 126A, 126B. Fasteners 212 and washers 214 are configured to be coupled to the axles 208 to secure the wheels 126A, 1266 to the axles 208. The axles 208 allow rotation of the wheels 126A, 126B about the axles 208. In at least some embodiments, bearings 216 may be arranged between the axles 208 and inner portions of the wheels 126A, 126B to facilitate rotation of the wheels 126A, 126B about the axles 208.

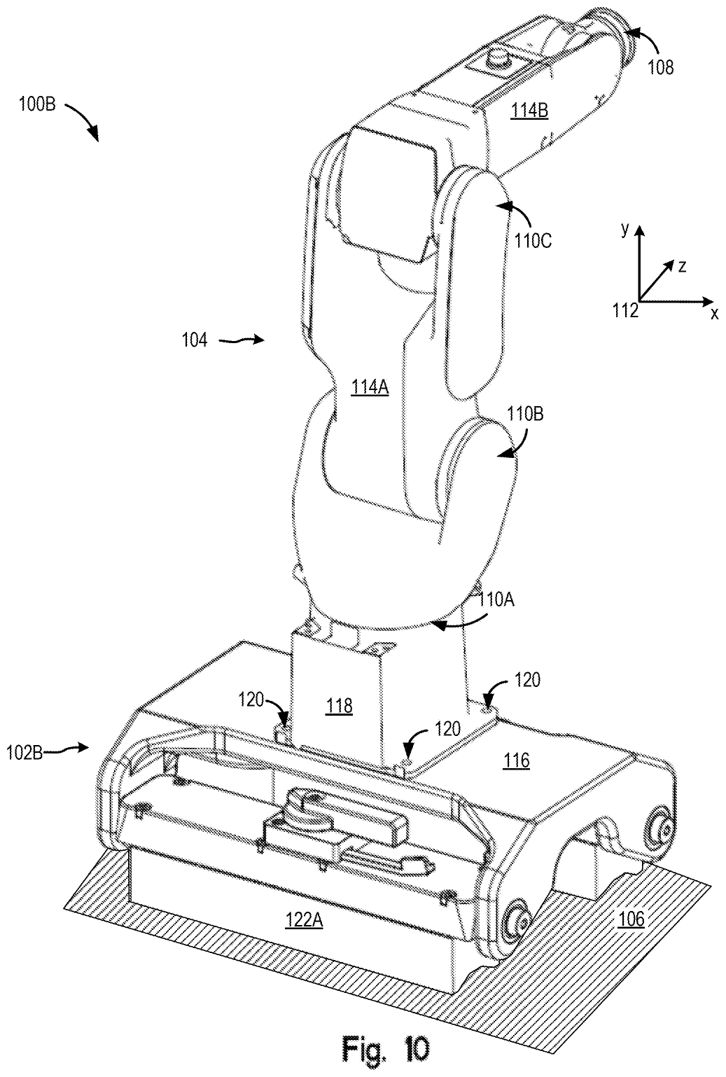

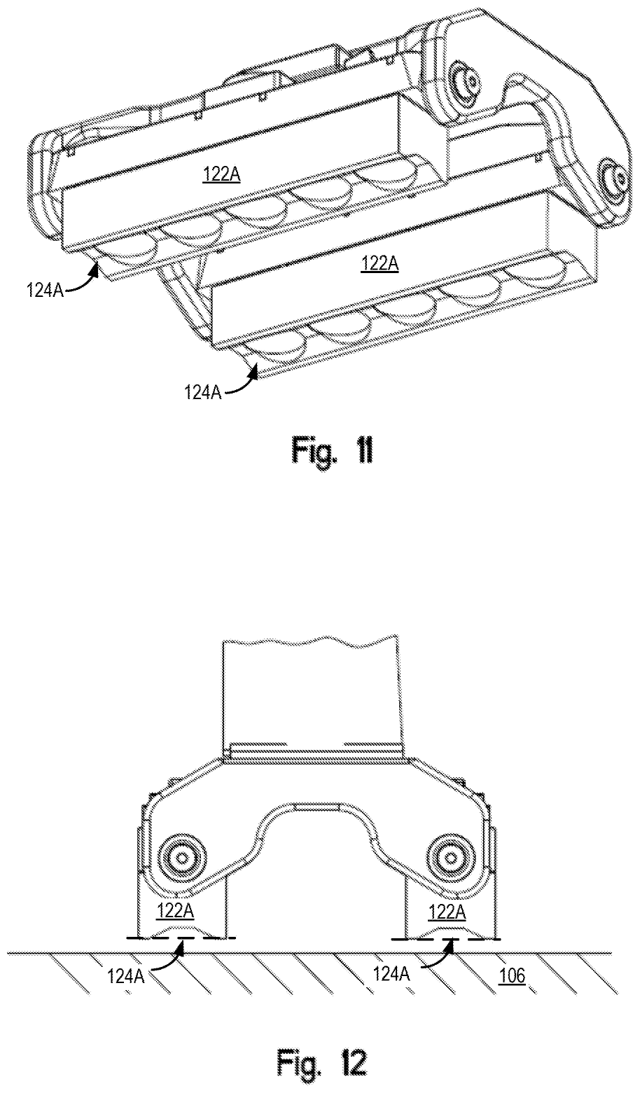

FIG. 10 illustrates a perspective view of another exemplary magnetic system 100B including a magnetic coupling device 102B coupled to a programmable machine 104A; FIG. 11 is a perspective view of the magnetic coupling device 102B and FIG. 12 is a side view of the magnetic coupling device 1026. Similar to the magnetic coupling device 102A, the magnetic coupling device 102B can be used to releasably secure the programmable machine 104A to a ferromagnetic surface 106. The programmable machine 104A can then perform one or more programmed functions. When the programmable machine 104A is finished performing one or more programmed functions at the desired location, the magnetic coupling device 102B may be de-actuated and the magnetic system 100B may be moved to another desired location and the process repeated. However, in the illustrated embodiment, the magnetic system 100B doesn't include wheel sets 126. Instead, the magnetic system 100B may be placed into various desired locations manually.

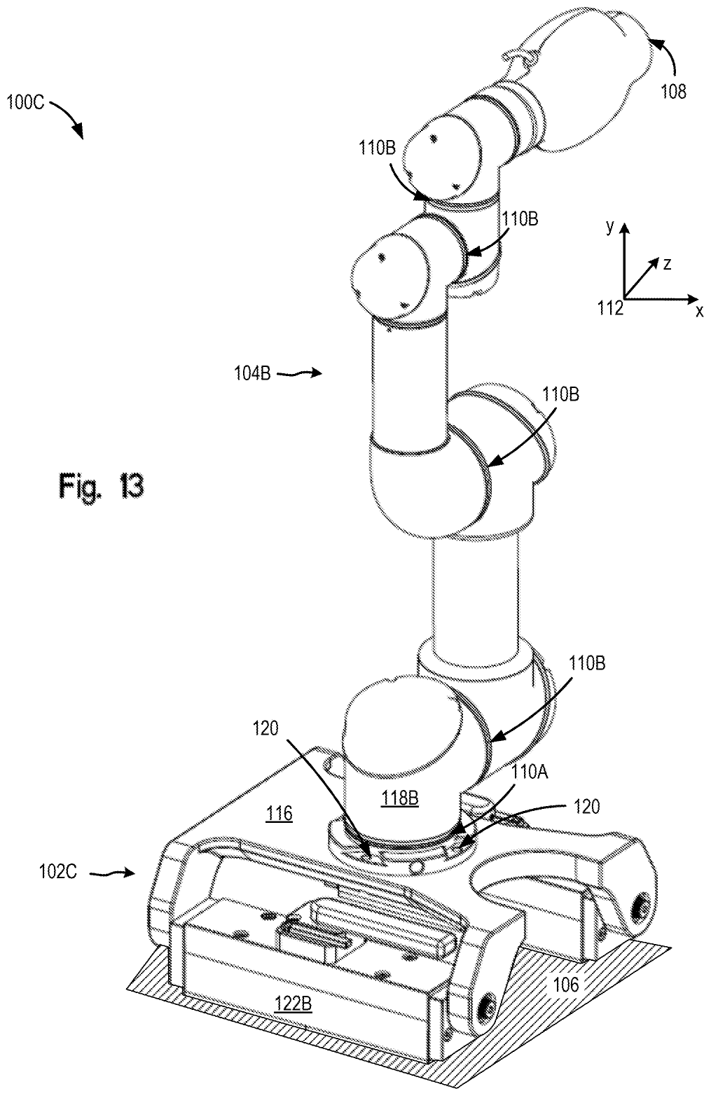

FIG. 13 illustrates a perspective view of another exemplary magnetic system 100C including a magnetic coupling device 102C coupled to a programmable machine 104B. Similar to the magnetic coupling devices 102A, 102B, the magnetic coupling device 102C can be used to releasably secure the programmable machine 104B to a ferromagnetic surface 106. The programmable machine 104B can then perform one or more programmed functions. When the programmable machine 104B is finished performing one or more programmed functions at the desired location, the magnetic coupling device 102C may be de-actuated and the magnetic system 100A may be moved to another desired location and the process repeated. Also, similar to the magnetic coupling device 1026, the magnetic coupling device 102C doesn't include wheel sets 126 and may be placed in various locations manually.

Additionally or alternatively, the programmable machine 104B may have similar functionality as the programmable machine 104A. In the illustrated embodiment, however, the programmable machine 104B may be a collaborative robot and satisfy any requirements related thereto. For example, the programmable machine 1046 may satisfy the safety requirements set forth in ISO 10218-2.

Similar to the programmable machine 104A, the programmable machine 1046 is a robotic arm and a plurality of different tools (not shown) can be attached to the end 108 of the robotic arm 104B. For example, manufacturing tools can be secured to the end 108 of the robotic arm 104B to facilitate autonomous or semi-autonomous manufacturing. More specifically, for example, a gripper (e.g., magnetic, vacuum, tactile, etc.) can be coupled to the end 108 to move pieces and/or to facilitate the assembly of a device. Other examples of manufacturing tools that can be secured to the end 108 of the robotic arm 104B include, but are not limited to, welders, sensors, injectors, sprayers, etc.

In some embodiments, other types of transporting systems, such as mechanical gantries, crane hoists and additional systems which lift and/or transport ferromagnetic workpieces, may be used as the programmable machine 104B or in place of the programmable machine 104B. In some embodiments, the programmable machine 104B is replaced by a manufacturing tool, such as a drill.

In the illustrated embodiment, the programmable machine 104B includes a plurality of pivot points 110. Due to the pivot points 110, the programmable machine 104B has plurality of degrees of freedom, allowing the programmable machine 104B to move and/or rotate along an x-axis, a y-axis, and a z-axis of the coordinate system 112.

A top portion 116 of the magnetic coupling device 102C is mechanically coupled to a base 118B of the programmable machine 104B. In at least one example, the base 118B is mechanically coupled to the top portion 116 via one or fasteners (e.g., bolts). The fasteners extend through apertures 120 in the base 118B and secure to threaded bores (not shown) into the top portion 116.

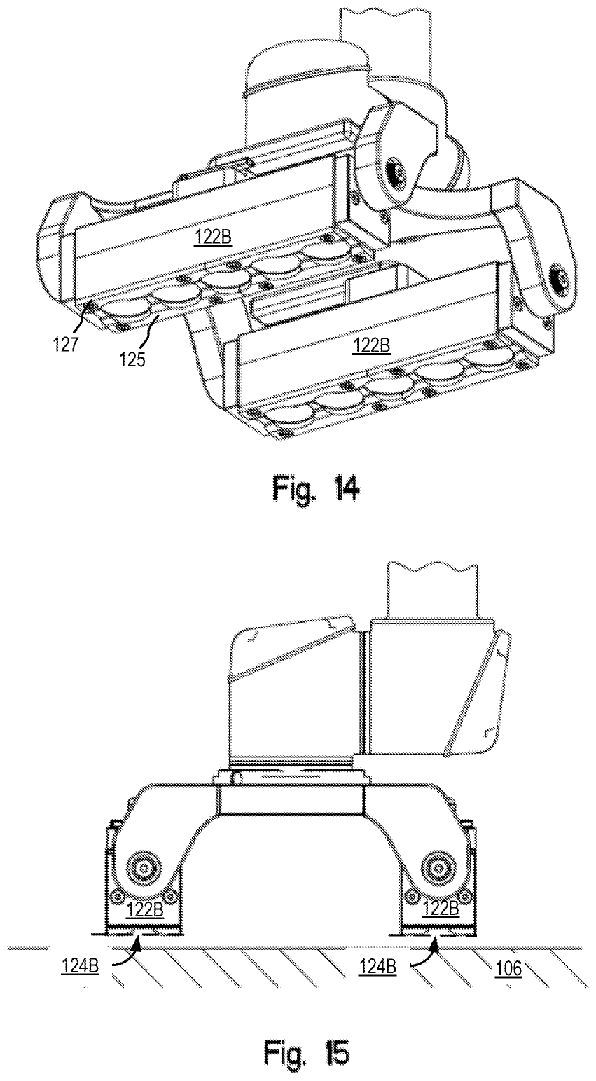

FIG. 14 is a perspective view of the magnetic coupling device 102C and FIG. 15 is a side view of the magnetic coupling device 102C. In the illustrated embodiment, the magnetic coupling device 102C includes two magnetic couplers 122B. Each of the magnetic couplers 122B is configured to switch between an “on state” and an “off state”. When a magnetic coupler 122B is in an on state, a magnetic circuit is created through a ferromagnetic workpiece and/or ferromagnetic surface 106 at a workpiece contact interface 124B. Alternatively, when a magnetic coupler 122B is in an off state, a magnetic circuit is not created through a ferromagnetic workpiece 106 at the workpiece contact interface 124B and instead is substantially contained within the housing of the magnetic coupler 122B. The internal components that enable the switching of the magnetic coupler 122B between an on state and an off state are described in more detail below.

As illustrated, the magnetic coupling device 102C also includes removeable pole plates 125 that form the workpiece contact interface 124B. The pole plates 125 are secured to the housing of the magnetic couplers 122B via fasteners 127. By removing the fasteners 127, the pole plates 125 can be removed and replaced with pole plates that are the same or similar to the pole plates 125. Alternatively, the pole plates 125 can be replaced with other types of pole plates (e.g., different thicknesses, including projections, and/or curved pole plates to fit different ferromagnetic workpieces having different radii or curvatures) that function differently than the pole plates 125. Characteristics of various types of pole plates are described in U.S. Provisional Patent Application No. 62/623,407, filed Jan. 29, 2018, titled MAGNETIC LIFTING DEVICE HAVING POLE SHOES WITH SPACED APART PROJECTIONS, docket MTI-0015-01-US-E, the entire disclosure of which are herein expressly incorporated by reference.

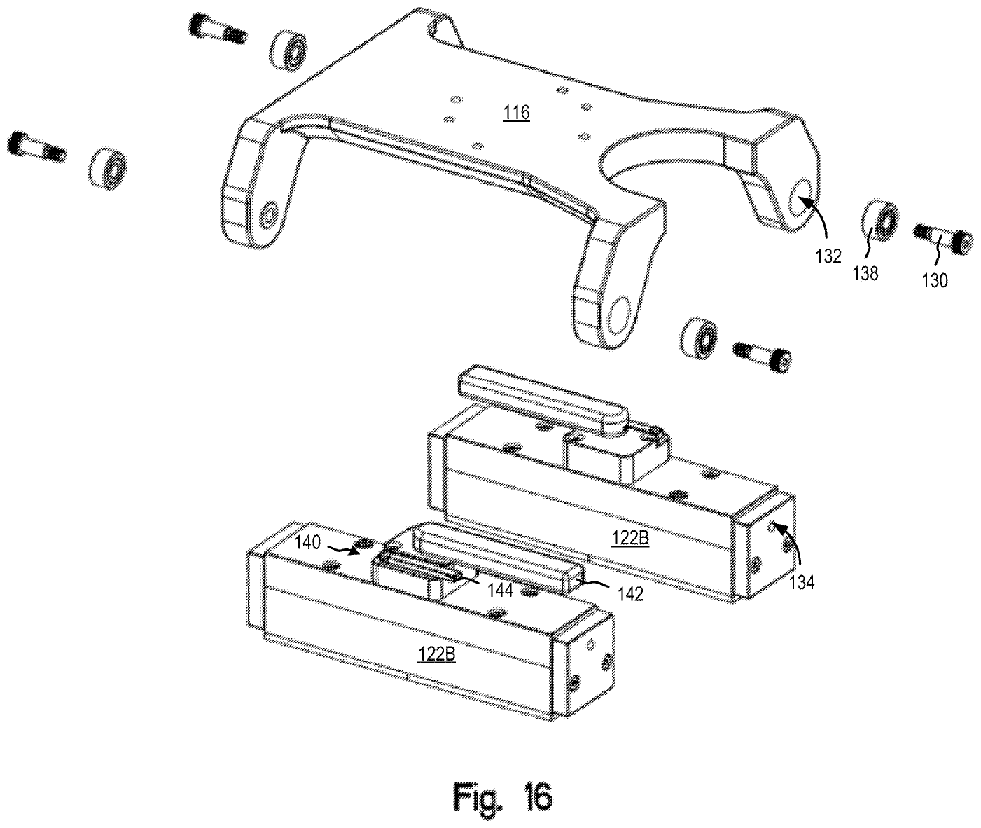

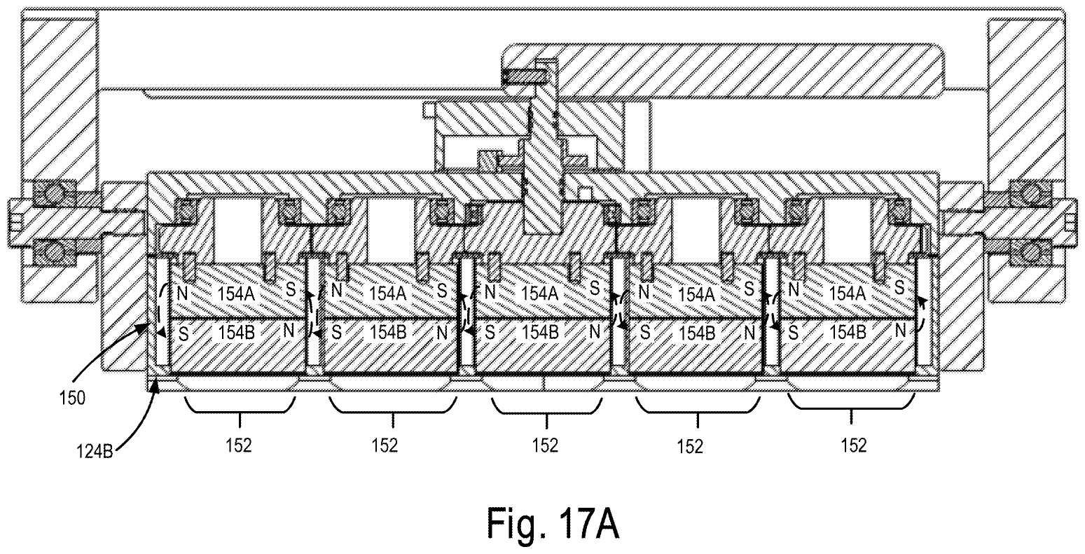

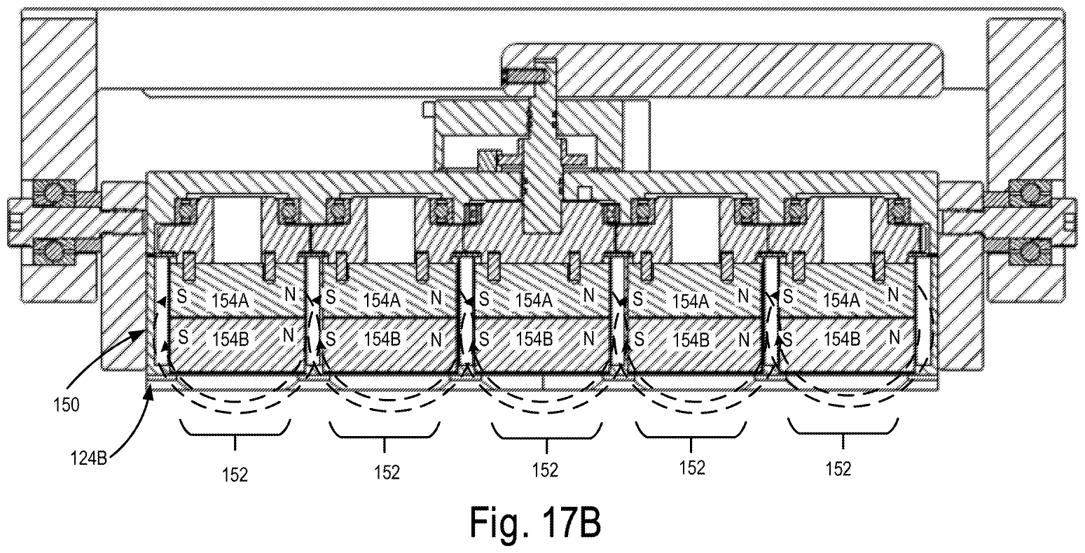

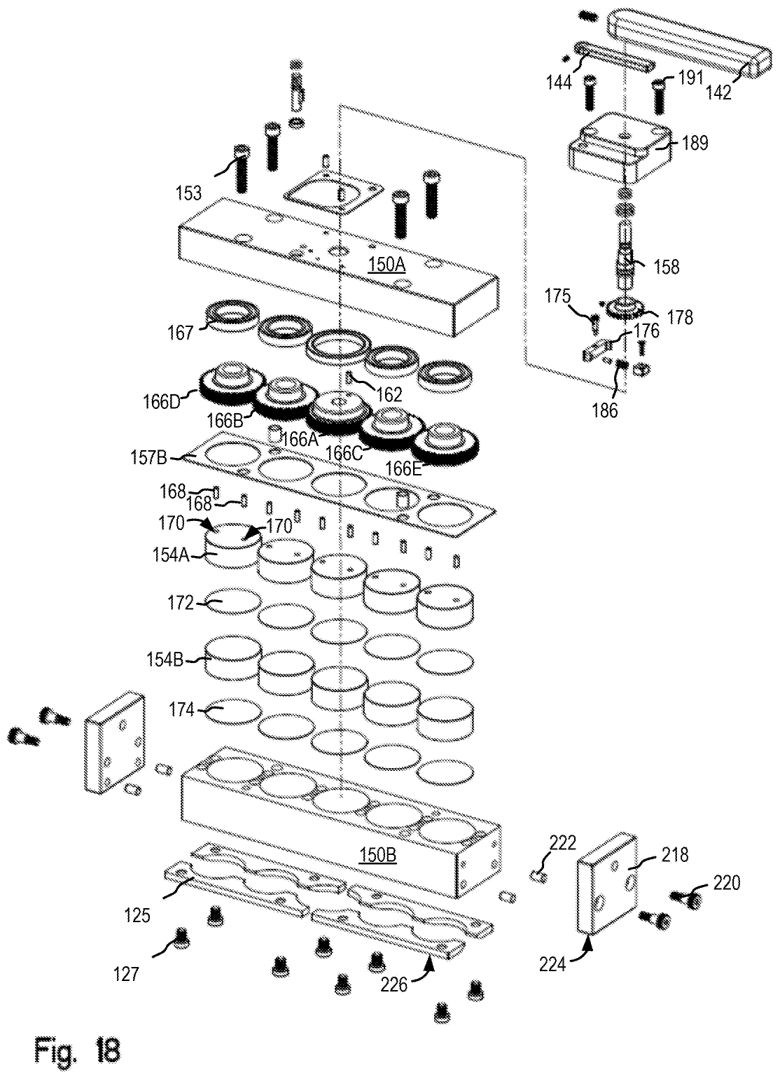

FIG. 16 depicts an exploded perspective view of the magnetic coupling device 102C. Similar to the magnetic couplers 122A, each of the magnetic couplers 122B includes an actuating mechanism 140. The actuating mechanism 140 includes an actuator 142 that turns the magnetic couplers 122B from an off state to an on state when the actuator 142 is rotated. The actuator 142 rotates an internal gear mechanism that rotates internal magnets relative to one another, as illustrated in FIGS. 17 and 18. To turn the magnetic coupler 122B from an on state to an off state, the actuating mechanism 140 may include a ratchet 144 that locks the magnetic coupler 122B in an on state and releases the magnetic coupler 122B from a locked on state when actuated, as discussed in more detail below in relation to FIG. 18.

FIGS. 17A-17B illustrate the cross section of the magnetic coupler 122B in an off state and an on state, respectively. As illustrated, the magnetic coupler 122B includes a housing 150 that houses groups of magnets 152. Each permanent magnet group 152 includes an upper permanent magnet 154A and a lower permanent magnet 154B positioned in a stacked relationship. While the illustrated embodiment includes five permanent magnet groups 152, in other embodiments, the magnetic coupler 122B includes greater than five magnetic groups 152 or less than five magnetic groups 152 (e.g., one magnetic group 152).

The upper permanent magnets 154A and the lower permanent magnets 154B are diametrically polarized and include north-pole portions and south-pole portions. The lower permanent magnets 154B are fixed within a housing of the magnetic coupler 122B and the upper permanent magnets 154A are rotatable relative to the lower permanent magnets 154B within the housing 150A. When the magnetic coupler 122A is in an off state, as illustrated in FIG. 17A, the N-pole portions of the upper permanent magnets 154A are arranged adjacent the S-pole portions of the lower permanent magnets 154B and the S-pole portions of the upper permanent magnets 154A are arranged adjacent the N-pole portions of the lower permanent magnets 154B. When the magnetic coupler 122B is in this configuration, the magnetic circuit is shunted and substantially confined with the housing 150. As such, the magnetic field produced by the magnetic coupler 122B at the workpiece contact interface 124B is substantially zero, as shown by the magnetic field lines in FIG. 17A. Conversely, when the magnetic coupler 122B is in an on state, as illustrated in FIG. 17B, the N-pole portions of the upper permanent magnets 154A are arranged adjacent the N-pole portions of the lower permanent magnets 154B and the S-pole portions of the upper permanent magnets 154A are arranged adjacent the S-pole portions of the lower permanent magnets 154B. When the magnetic coupler 122B is in this configuration, the magnetic field produced by the magnetic groups 152 is non-zero at the workpiece contact interface 124B and a magnetic circuit is created through the ferromagnetic surface 106.

In at least some embodiments, the upper permanent magnets 154A can be rotated to a position between the off state depicted in FIG. 17A and the on state depicted in FIG. 17B, referred to herein as a partial on state. When the magnetic coupler 122B is in a partial on state, the magnetic field at the workpiece contact interface 124B is non-zero but is less than the magnetic field produced by the magnetic coupler 122B when the magnetic coupler 122B is in a fully on state. As such, the magnetic coupler 122B produces a magnetic circuit with the ferromagnetic surface 106 that is weaker than the magnetic circuit produced when the magnetic couple 122B is in a fully on state. By being able to partially activate the magnetic couplers 122B, different strength magnetic circuits can be created with a ferromagnetic surface 106.

FIG. 18 illustrates an exploded view of the magnetic coupler 122B. As illustrated, the magnetic coupler 122B includes similar features as the magnetic coupler 122A. The magnetic coupler 122B, however, also includes pole plates 125 that are releasable secured to the lower housing portion 150B by fasteners 127. In at least some embodiments, the magnetic coupler 122B also includes pole portions 218 releasably coupled to the ends of the lower housing portion 150B via fasteners 220. The pole portions 218 facilitate transferring magnetic flux to the ferromagnetic surface 106 when the magnetic coupler 122B is an on state. In the illustrated embodiment, the magnetic coupler 122B also includes pins 222 configured to facilitate alignment of the bottom surface 224 of the pole portions 218 and the bottom surface 226 of the pole plates 125. When aligned, the bottom surface 224 and the bottom surface 226 collectively form the workpiece contact interface 124B.

FIG. 19 is a block diagram of an exemplary magnetic system 300. The illustrated embodiment includes a magnetic coupling device 302 and a programmable machine 304. The programmable machine 304 may have some or all of the same functionality as one of the programmable machines 104. In at least one example, the programmable machine 304 is a robotic arm and a plurality of different tools (not shown) can be attached to the programmable machine 304.

Similarly, the magnetic coupling device 302 may have some or all of the same functionality as one or more of the magnetic coupling devices 102. For example, the magnetic coupling device 302 may be actuatable between an off state and an on state and vice versa by rotating an upper magnet(s) of the magnetic coupling device 302 relative to lower magnet(s) of the magnetic coupling device 302. When in an on state, a magnetic circuit is formed through a ferromagnetic surface 306 and the magnetic coupling device 302. When in an off state, a magnetic circuit is substantially confined within the magnetic coupling device 302.

To switch the magnetic coupling device 302 between an on state and an off state, the magnetic system 300 includes an actuator system 308 including a magnetic coupler actuator 310. The magnetic coupler actuator 310 may be configured to rotate an upper magnet (e.g., upper magnet 154A) included in the magnetic coupling device 302 relative to a lower magnet (e.g., the lower magnet 154B) included in the magnetic coupling device 302. Exemplary types of actuators that may be used as the magnetic coupler actuators include but are not limited to electrical actuators, pneumatic actuators, and hydraulic actuators. Exemplary actuators are disclosed in U.S. Pat. No. 7,012,495, titled SWITCHABLE PERMANENT MAGNETIC DEVICE; U.S. Pat. No. 7,161,451, titled MODULAR PERMANENT MAGNET CHUCK; U.S. Pat. No. 8,878,639, titled MAGNET ARRAYS, U.S. Provisional Patent Application No. 62/248,804, filed Oct. 30, 2015, titled MAGNETIC COUPLING DEVICE WITH A ROTARY ACTUATION SYSTEM, docket MTI-0007-01-US-E; and U.S. Provisional Patent Application No. 62/252,435, filed Nov. 7, 2015, titled MAGNETIC COUPLING DEVICE WITH A LINEAR ACTUATION SYSTEM, docket MTI-0006-01-US-E, the entire disclosures of which are herein expressly incorporated by reference. In some embodiments, the magnetic coupling device 302 may include a non-moveable switchable upper magnet 154A such that when the upper magnet 154A is in a first state the N-pole portion of the upper magnet 154A is adjacent the S-pole portion of the lower magnet 1546 and the S-pole portion of the lower magnet 1546 is adjacent the N-pole portion of the lower magnet 1546 and the magnetic coupling device 302 is in an off state. Additionally, when the upper magnet 154 is in a second state the N-pole portion of the upper magnet 154A is adjacent the N-pole portion of the lower magnet 1546 and the S-pole portion of the lower magnet 1546 is adjacent the S-pole portion of the lower magnet 154B and the magnetic coupling device 302 is in an on state. In these embodiments, the upper magnet 154A may be switched between the first state and the second state by an electric field.

In at least one exemplary embodiment, the magnetic coupling device 302 includes a wheel set 311. In at least another exemplary embodiment, the magnetic coupling device 302 doesn't include a wheel set 311. In the exemplary embodiment including the wheel set 311, the wheel set 311 facilitates transportation of the magnetic system 300 to a desired location. Once the magnetic system 300 is at a desired location, a wheel set linear actuator 312 included in the actuator system 308 may translate the wheel set 311 upward along a vertical axis 313 until the workpiece contact interface 314 of the magnetic coupling device 302 contacts the ferromagnetic surface 306. Once the workpiece contact interface 314 of the magnetic coupling device 302 contacts the ferromagnetic surface 306, the magnetic coupler actuator 310 actuates the magnetic coupling device 302 to secure the magnetic coupling device 302 to the ferromagnetic surface 306. Once the magnetic coupling device 302 is secured to the ferromagnetic surface 306, the programmable machine 304 can perform one or more programmed functions.

Conversely, when the programmable machine 304 is finished performing one or more programmed functions at a specific location, the magnetic coupler actuator 310 may transition the magnetic coupling device 302 from an on state to an off state and the wheel set linear actuator 312 translates the wheel sets 311 downward along a vertical axis 313 to create separation between the workpiece contact interface 314 and the ferromagnetic surface 306. Then, the magnetic system 300 can be relocated to another desired location. The wheel set linear actuator 312 may be electrical, pneumatic, or hydraulic. In at least one exemplary embodiment, the magnetic system 300 can be steered to different locations either locally or remotely via a motor and steering mechanism (not shown) attached to the wheel sets 311. Alternatively, the magnetic system 300 can be autonomously steered to different locations, as described in more detail below.

As described above, the wheel sets 311 may include magnets (e.g., magnets 192A, 192B). The magnets included in the wheel sets 311 can be configured to facilitate maintaining contact between the magnetic system 300 and the ferromagnetic surface 306. In at least one exemplary embodiment, the actuator system 308 includes a wheel set magnetic actuator 316. Exemplary actuators are disclosed in U.S. Pat. No. 7,012,495, titled SWITCHABLE PERMANENT MAGNETIC DEVICE; U.S. Pat. No. 7,161,451, titled MODULAR PERMANENT MAGNET CHUCK; U.S. Pat. No. 8,878,639, titled MAGNET ARRAYS, U.S. Provisional Patent Application No. 62/248,804, filed Oct. 30, 2015, titled MAGNETIC COUPLING DEVICE WITH A ROTARY ACTUATION SYSTEM, docket MTI-0007-01-US-E; and U.S. Provisional Patent Application No. 62/252,435, filed Nov. 7, 2015, titled MAGNETIC COUPLING DEVICE WITH A LINEAR ACTUATION SYSTEM, docket MTI-0006-01-US-E, the entire disclosures of which are herein expressly incorporated by reference.

In the illustrated embodiment, the magnetic system 300 includes a controller 318. The controller 318 includes a processor 320 with an associated computer readable medium, illustratively memory 322. Memory 322 includes control logic 324 which when executed by processor 320 causes electronic controller 318 to instruct actuator system 308 to actuate one or more of its actuators 310, 312, 316. Additionally or alternatively, the control logic 324 controls relocating the magnetic system 300 to various locations by controlling a motor and steering system (not shown) coupled to the wheel set 311.

In the illustrated embodiment, the memory includes a programmable machine module 326. The programmable machine module 326 controls movement of the programmable machine 304 and any functions to be performed by the programmable machine 304.

In at least some embodiments, the controller 318 changes the state of magnetic system 300 in response to an input signal received from an I/O device 328. Exemplary I/O devices 328 include discrete I/O devices, analog I/O devices, digital I/O devices and/or the like. For example, input devices include buttons, switches, levers, dials, touch displays, pneumatic valves, soft keys, and communication modules. Exemplary output devices include visual indicators, audio indicators, and communication module. Exemplary visual indicators include displays, lights, and other visual systems. Exemplary audio indicators include speakers and other suitable audio systems.

In at least some embodiments, the magnetic system 300 can include a sensor system 330. While the sensor system 330 is depicted as being included in the magnetic coupling device 302, in other embodiments, the sensor system 330 can be included in the programmable machine 304 or a controller 318 for the magnetic system 300.

In at least one example, the sensor system 330 determines the location of the magnetic coupling system 300 based on, for example, inertial system measurements, navigation system measurements, and/or visual indicator measurements. In these embodiments, the sensor system 330 can coordinate with the controller 318 to autonomously determine a desired location for the magnetic system 300. For visual indicator measurements, the sensor system 330 in coordination with the controller 318 can use machine learning to identify one or more desired locations for the programmable machine 304 to perform one or more programmed functions.

In at least another example, the sensor system 330 senses the breakaway force between the magnetic coupling device 302 and the ferromagnetic surface 306. To determine the breakaway force, the sensor system 330 includes one or more sensors configured to determine the position of the magnetic coupler actuator 310 and/or one or more magnetic field sensors that sense leakage flux as described in U.S. patent application Ser. No. 15/964,884, titled “MAGNETIC COUPLING DEVICE WITH AT LEAST ONE OF A SENSOR ARRANGEMENT AND A DEGAUSS CAPABILITY, filed Apr. 27, 2018, the entire disclosure of which is herein expressly incorporated by reference. After sensing a position of the magnetic coupler actuator 310 and/or a leakage flux, the sensor system 330 can send a signal corresponding to position of the magnetic coupler actuator 310 and/or the leakage flux to a controller 318. Based on the sensed signal, the controller 318 can determine the breakaway force of the magnetic system 300. In at least some embodiments, the controller 318 can also access a lookup table and compare the determined breakaway force with a breakaway force required for one or more functions to be performed by the programmable machine 304 at the location of the magnetic system 300. If the sensed breakaway force is less than the breakaway force required for one or more programmed functions of the programmable machine 304, the controller 318 can restrict the programmable machine 304 from performing all functions or any of the programmed functions that would exceed the determined breakaway force. In at least some embodiments, the controller 318 can also determine whether the workpiece contact interface 314 has insufficient contact with the ferromagnetic surface 306, as described in U.S. patent application Ser. No. 15/964,884. In the event the workpiece contact interface 314 has insufficient contact, the controller 318 can reposition the magnetic system 300 using, for example, the wheel sets 311, to improve the contact between the workpiece contact interface 314 and the ferromagnetic surface 306 and increase the breakaway force therebetween.

In embodiments, magnetic system 300 includes simple visual status indicators via the I/O device 328, in the form of one or more LEDs, which are driven by the processor 320 of control logic 324, to indicate when a predefined magnetic system 300 status is present or absent (e.g. Red LED on when magnetic system 300 is in an off state, Green LED blinking fast when magnetic system 300 is in a second, on state and proximity of ferromagnetic workpiece 306 is detected, Green LED slower blinking with Yellow LED on when contacting ferromagnetic workpiece 306 outside intended specific area on ferromagnetic workpiece 306 (e.g. partially complete magnetic working circuit), as described in in U.S. patent application Ser. No. 15/964,884, and/or when the breakaway force between the workpiece contact interface 314 and the ferromagnetic surface 306 is below the breakaway force required for one or more programmed functions of the programmable machine 304, and Yellow LED off with steady Green LED on, showing magnetic system 300 engagement within threshold limits, showing safe magnetic coupling state to perform any programmed functions of the programmable machine 304.

For example, in one embodiment, the I/O device 328 is a network interface over which controller 318 receives instructions from a robot controller on when to place magnetic coupling device 302 in one of an off state or an on state and performed one or more programmed functions of the programmable machine 304. Exemplary network interfaces include a wired network connection and an antenna for a wireless network connection.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

1. A magnetic system for coupling to a ferromagnetic workpiece, the magnetic system comprising:
a robotic arm comprising at least one pivot joint configured to allow the robotic arm to move in at least one direction;
a magnetic base coupled to the robotic arm and configured to support the robotic arm, the magnetic base comprising:
a magnetic coupler comprising a workpiece contact interface and a magnet assembly configurable between an off state and an on state, the off state producing a first magnetic field at the workpiece contact interface and the on state producing a second magnetic field at the workpiece contact interface, the second magnetic field being greater than the first magnetic field; and
a wheel coupled to the magnetic base and configured to rotate about an axis, the wheel positionable to support the magnetic base to permit a movement of the magnetic system with the workpiece contact interface of the magnetic coupler positioned between a portion of the wheel and a portion of the robotic arm.

2. The magnetic system of claim 1, the wheel is further configured to swivel about a vertical axis angled relative to the axis.

3. The magnetic system of claim 1, the wheel is moveable between a first position wherein the magnetic coupler is contacting the ferromagnetic workpiece and a second position wherein the magnetic coupler is spaced apart from the ferromagnetic workpiece, optionally the wheel is further configured to vertically translate along a vertical axis between the first position and the second position.

4. The magnetic system of claim 1, the magnetic base comprising a wheel set including the wheel, wherein the wheel set comprises two or more wheels.

5. The magnetic system of claim 4, the wheel set comprising a housing arranged between the two or more wheels, wherein the housing comprises a wheel magnet assembly configurable between an on state and an off state, the on state producing a magnetic field external to the housing that is greater than an external magnetic field produced by the off state.

6. The magnetic system of claim 5, wherein the on state and the off state of the wheel magnet assembly is configurable independent of the on state and the off state of the magnet assembly of the magnetic coupler.

7. The magnetic system of claim 1, the wheel magnet assembly configurable to a partial on state, the partial on state producing a magnetic field external to the housing that is less than the external magnetic field produced when the wheel magnet assembly is in the on state and is greater than the external magnetic field produced when the wheel magnet assembly is in the off state.

8. The magnetic system of claim 1, the magnetic base comprising more than one wheel set, wherein each wheel set comprises two or more wheels.

9. The magnetic system of claim 1, the magnetic base comprising a manual actuator, an electrical actuator, a pneumatic actuator, or a hydraulic actuator configured to actuate the magnet assembly between the off state and the on state.

10. The magnetic system of claim 1, the magnetic base comprising a ratchet configured to retain the magnet assembly in either the off state or the on state.

11. The magnetic system of claim 1, the at least one magnet configured to be actuated to a partial on state, the partial on state producing a third magnetic field at the workpiece contact interface, the third magnetic field being greater than the first magnetic field and less than the second magnetic field.

12. The magnetic system of claim 11, the magnetic base comprising a manual actuator, an electrical actuator, a pneumatic actuator, or a hydraulic actuator configured to actuate the magnet assembly to the partial on state.

13. The magnetic system of claim 1, further comprising a sensing system configured to sense when the magnetic coupler has insufficient contact with the ferromagnetic workpiece.

14. The magnetic system of claim 1, further comprising a sensing system configured to sense a breakaway force of the magnetic base.

15. The magnetic system of claim 14, further comprising a controller configured to lookup a breakaway force required to perform a programmable function of the robotic arm and prevent the programmable function from being performed when the breakaway force sensed by the sensing system is less than the breakaway force for the programmable function.

16. The magnetic system of claim 1, further comprising a sensing system configured to sense a location of the magnetic system on a ferromagnetic workpiece.

17. The magnetic system of claim 1, further comprising a programmable machine module configured to control movement of the magnetic system via rotation of the wheel.

18. The magnetic system of claim 1, wherein the magnetic assembly comprises a first permanent magnet and a second permanent magnet in a stacked relationship with the first permanent magnet, wherein the magnet assembly produces the first magnetic field at the workpiece contact interface when the second permanent magnet is in a first state relative to the first permanent magnet and the magnet assembly produces the second magnetic field at the workpiece contact interface when the second permanent magnet is in a second state relative to the first permanent magnet.

19. A non-transitory computer-readable medium comprising instructions that when executed by a processor cause the processor to:
relocate a magnetic system from a first location on a ferromagnetic workpiece to a second location on the ferromagnetic workpiece using a wheel positioned on a first side of a robotic arm of the magnetic system and incorporated into the magnetic system, the magnetic system further comprising:
the robotic arm comprising at least one pivot joint configured to allow the robotic arm to move in at least one direction;
a magnetic base positioned on the first side of the robotic arm, coupled to the robotic arm, and configured to support the robotic arm, the magnetic base comprising:
a magnetic coupler comprising a workpiece contact interface and a magnet assembly configurable between an off state and an on state, the off state producing a first magnetic field at the workpiece contact interface and the on state producing a second magnetic field at the workpiece contact interface, the second magnetic field being greater than the first magnetic field; and
the wheel configured to rotate about an axis; and
transition the at least one magnet from the off state to the on state.

20. The non-transitory computer readable medium of claim 19, further comprising instructions that when executed by the processor cause the processor to:
transition the at least one magnet from the on state to the off state;
relocate the magnetic system from the second location to a third location on the ferromagnetic workpiece; and
transition the at least one magnet from the off state to the on state.

21. A magnetic base configured to be coupled to a tool and support the tool, the magnetic base comprising:
a magnetic coupler comprising a workpiece contact interface and a magnet assembly configured to be actuated between an off state and an on state, the off state producing a first magnetic field at the workpiece contact interface and the on state producing a second magnetic field at the workpiece contact interface, the second magnetic field being greater than the first magnetic field; and
a wheel moveable relative to the magnetic coupler to a position extending below the workpiece contact interface and configured to rotate about an axis to permit movement of the magnetic base.

22. A magnetic system for coupling to a ferromagnetic workpiece, the magnetic system comprising:
an articulating programmable machine;
a controller operatively coupled to the articulating programmable machine to control a position of an end of the articulating programmable machine relative to the ferromagnetic workpiece;
a magnetic base supporting the articulating programmable machine, the magnetic base including magnetic coupling means for selectively coupling a workpiece contact interface of the magnetic base to the ferromagnetic workpiece to stabilize the articulating programmable machine relative to the ferromagnetic workpiece and transport means for moving the magnetic system from a first location relative to the ferromagnetic workpiece to a second location relative to the ferromagnetic workpiece while the workpiece contact interface of the magnetic coupling means is facing the ferromagnetic workpiece and decoupled from the ferromagnetic workpiece.

23. A magnetic system for coupling to a ferromagnetic workpiece, the magnetic system comprising:
a robotic arm comprising at least one pivot joint configured to allow the robotic arm to move in at least one direction;
a magnetic base coupled to the robotic arm and configured to support the robotic arm, the magnetic base comprising:
a plurality of magnetic couplers each comprising a workpiece contact interface and a magnet assembly configurable between an off state and an on state, the off state producing a first magnetic field at the workpiece contact interface and the on state producing a second magnetic field at the workpiece contact interface, the second magnetic field being greater than the first magnetic field; and
a transport system coupled to the magnetic base and positioned between a first magnetic coupler of the plurality of magnetic couplers and a second magnetic coupler of the plurality of magnetic couplers to support the magnetic base to permit a movement of the magnetic system.

24. The magnetic system of claim 23, the transport system comprising a housing, wherein the housing comprises a transport magnet assembly configurable between an on state and an off state.

25. The magnetic system of claim 24, wherein the on state and the off state of the transport magnet assembly is configurable independent of the on state and the off state of the magnet assembly of the magnetic coupler.

26. A magnetic system for coupling to a ferromagnetic workpiece, the magnetic system comprising:
a robotic arm comprising at least one pivot joint configured to allow the robotic arm to move in at least one direction;
a magnetic base coupled to the robotic arm and configured to support the robotic arm, the magnetic base comprising:
a magnetic coupler comprising a workpiece contact interface and a magnet assembly configurable between an off state and an on state, the off state producing a first magnetic field at the workpiece contact interface and the on state producing a second magnetic field at the workpiece contact interface, the second magnetic field being greater than the first magnetic field; and
a transport system coupled to the magnetic base and positioned to support the magnetic base to permit a movement of the magnetic system;
a sensing system configured to sense a breakaway force of the magnetic base; and
a controller configured to lookup a breakaway force required to perform a programmable function of the robotic arm and prevent the programmable function from being performed when the breakaway force sensed by the sensing system is less than the breakaway force for the programmable function.

27. A magnetic system for coupling to a ferromagnetic workpiece, the magnetic system comprising:
a robotic arm comprising at least one pivot joint configured to allow the robotic arm to move in at least one direction;
a magnetic base coupled to the robotic arm and configured to support the robotic arm, the magnetic base comprising:
a magnetic coupler comprising a workpiece contact interface and a magnet assembly configurable between an off state and an on state, the off state producing a first magnetic field at the workpiece contact interface and the on state producing a second magnetic field at the workpiece contact interface, the second magnetic field being greater than the first magnetic field;
a wheel coupled to the magnetic base and configured to rotate about an axis, the wheel positionable to support the magnetic base to permit a movement of the magnetic system; and
a sensing system configured to sense when the magnetic coupler has insufficient contact with the ferromagnetic workpiece.
